(19) United States
(12) Patent Application Publication
(10) Pub. No.: US 2020/0003111 A1
(43) Pub. Date: Jan. 2, 2020

(54) VARIABLE FLOWRATE VALVE MECHANISM AND TURBOCHARGER

(71) Applicant: IHI Corporation, Koto-ku (JP)

(72) Inventor: Jaemin HUH, Koto-ku (JP)

(73) Assignee: IHI Corporation, Koto-ku (JP)

(21) Appl. No.: 16/339,506

(22) PCT Filed: Nov. 1, 2017
(86) PCT No.: PCT/JP2017/039563

§ 371 Date: Apr. 4, 2019

(30) Foreign Application Priority Data
Nov. 4, 2016 (JP) 2016-216472

(51) Int. Cl. F02B 37/18; F16F 1/02; F15B 15/10; F16F 7/116

(52) U.S. Cl. CPC F02B 37/186; F16F 1/027; F05D 2220/40; F16F 7/116; F15B 15/10

(57) ABSTRACT

A variable flowrate valve mechanism includes: a valve body that opens and closes the opening portion; a stem of which one end is connected to the valve body and is supported so as to be rotatable relative to a housing; an operating rod that is connected to an actuator and reciprocates; a link member of which one end is connected to the stem and the other end is connected to the operating rod and which extends in a direction crossing the stem and the operating rod; and a biasing member that is connected to a pair of connecting units disposed on both sides of the link member in a direction where the operating rod reciprocates, is bent so as to protrude outward in a longitudinal direction of the link member, and presses the link member in the longitudinal direction of the link member.

### TECHNICAL FIELD

The present disclosure relates to a variable flowrate valve mechanism and a turbocharger. This application is based on Japanese Patent Application No. 2016-216472, filed on Nov. 4, 2016. This application claims the advantage of priority on Japanese Patent Application No. 2016-216472. The content of Japanese Patent Application No. 2016-216472 is incorporated in this application by reference.

### BACKGROUND ART

A variable flowrate valve mechanism has been known in the past (for example, see Patent Literature 1). The variable flowrate valve mechanism adjusts the flow rate of working fluid that is supplied to a turbine of a turbocharger. The variable flowrate valve mechanism includes bearings, a rotating shaft, and a valve body. The bearings are provided in a turbine housing that receives a turbine. The rotating shaft is rotatably supported by the bearings. The valve body is connected to one end of the rotating shaft. The valve body is connected to the rotating shaft through a valve arm that protrudes in the radial direction of the rotating shaft. Further, since the rotating shaft is rotated about an axis, the valve arm swings. Since the valve arm swings, the valve body approaches or is separated from a valve seat. Further, since the valve body approaches or is separated from the valve seat, the flow rate of working fluid is adjusted.

### CITATION LIST

### Patent Literature

Patent Literature 1: Japanese Unexamined Patent Publication No. 2013-130133

### SUMMARY OF INVENTION

### Technical Problem

In the related art disclosed in Patent Literature 1, there is a concern that the valve body may vibrate due to the pulsation of working fluid when the valve body is in an open state and the working fluid passes through an opening portion of a variable flow rate passage. Further, there is a clearance between components, such as the valve body, the valve arm, the rotating shaft (stem), a link member connected to the rotating shaft, and an operating rod connected to the link member. Since the vibration of the valve body is transmitted to each component, there is a concern that each component may vibrate.

This disclosure describes a variable flowrate valve mechanism and a turbocharger that can suppress the vibration of a link member which is a component connected to a valve body.

### Solution to Problem

This disclosure provides a variable flowrate valve mechanism that opens and closes an opening portion of a variable gas-flow-rate passage. The variable flowrate valve mechanism includes: a valve body that opens and closes the opening portion; a stem of which one end is connected to the valve body, passes through a housing, and is supported so as to be rotatable relative to the housing; an operating rod that is connected to an actuator and reciprocates; a link member of which one end is connected to the stem and the other end is connected to the operating rod and which extends in a direction crossing the stem and the operating rod and swings about an axis of the stem; and a biasing member that is connected to a pair of connecting units disposed on both sides of the link member in a direction where the operating rod reciprocates, is bent so as to protrude outward in a longitudinal direction of the link member, and presses the link member in the longitudinal direction of the link member.

### Effects of Invention

According to a variable flowrate valve mechanism and a turbocharger of this disclosure, it is possible to suppress the vibration of a link member that is a component connected to a valve body.

### BRIEF DESCRIPTION OF DRAWINGS

FIG. 1 is a cross-sectional view of a turbocharger according to a first embodiment.

FIG. 2 is a side view of a turbine housing of the turbocharger illustrated in FIG. 1.

FIG. 3 is a cross-sectional view taken along line III-III of FIG. 2.

FIG. 4 is a perspective view of a vibration suppression unit that is mounted on an operating rod.

FIG. 5 is a cross-sectional view of the vibration suppression unit illustrated in FIG. 4.

FIG. 6 is a perspective view of a vibration suppression unit according to a second embodiment.

FIG. 7 is a side view of a vibration suppression unit according to a third embodiment.

### DESCRIPTION OF EMBODIMENTS

This disclosure provides a variable flowrate valve mechanism that opens and closes an opening portion of a variable gas-flow-rate passage. The variable flowrate valve mechanism includes: a valve body that opens and closes the opening portion; a stem of which one end is connected to the valve body, passes through a housing, and is supported so as to be rotatable relative to the housing; an operating rod that is connected to an actuator and reciprocates; a link member of which one end is connected to the stem and the other end is connected to the operating rod and which extends in a direction crossing the stem and the operating rod and swings about an axis of the stem; and a biasing member that is connected to a pair of connecting units disposed on both sides of the link member in a direction where the operating rod reciprocates, is bent so as to protrude outward in a longitudinal direction of the link member, and presses the link member in the longitudinal direction of the link member.

In the variable flowrate valve mechanism, the operating rod connected to the actuator reciprocates. The link member connected to the operating rod swings due to the reciprocation. The stem moves rotationally about the axis of the stem due to the swing. When the stem moves rotationally through the housing, the valve body connected to one end of the stem approaches the opening portion of the variable gas-flow-rate passage. Accordingly, the valve body closes the opening portion. Further, when the valve body is separated from the opening portion of the variable gas-flow-rate passage, the valve body opens the opening portion. Accordingly, the flow rate of gas passing through the variable gas-flow-rate passage can be adjusted. Furthermore, in the variable flowrate valve mechanism, the pair of connecting units is provided on both sides of the link member in the direction where the operating rod reciprocates. The link member is disposed between the pair of connecting units. The biasing member, which is connected to the pair of connecting units, is bent so as to protrude outward in the longitudinal direction of the link member. The biasing member presses the link member in the longitudinal direction of the link member due to the bending of the biasing member. Accordingly, the biasing member damps the vibration of the link member. For this reason, the vibration of the link member in the longitudinal direction is suppressed. Further, the vibration of the stem in the radial direction is suppressed. Accordingly, the vibration of the valve body connected to the stem is damped.

At least one of the pair of connecting units may be provided on the operating rod. Accordingly, at least one end of the biasing member in the longitudinal direction can be connected to the operating rod. Further, the vibration of the link member with respect to the operating rod can be suppressed. For this reason, vibration, which is transmitted to the operating rod from the link member, can be suppressed.

The operating rod may include a protruding portion that protrudes to one side of a portion of the operating rod, which is connected to the other end of the link member, opposite to the actuator, and a first connecting unit, which is disposed on one side opposite to the actuator, of the pair of connecting units may be provided on the protruding portion. In a case where the operating rod is provided with the protruding portion and the protruding portion is provided on the protruding portion as described above, one end (an end opposite to the actuator) of the biasing member in the longitudinal direction can be connected to the protruding portion of the operating rod. According to this structure, the vibration of the link member can be suppressed with respect to the operating rod.

A second connecting unit, which is disposed on one side facing the actuator, of the pair of connecting units may be provided on a bracket that supports the actuator. As described above, one end (an end facing the actuator) of the biasing member in the longitudinal direction can be connected to the bracket that supports the actuator.

At least one of the pair of connecting units may include an elastic part that is connected to the biasing member. A force acting on the biasing member is reduced by the elastic part. Accordingly, the vibration of the link member is further reduced.

The biasing member may be in contact with the other end of the link member and may press the link member toward one end of the link member. The other end of the link member is an end that is connected to the operating rod. Accordingly, the position of the other end of the link member is changed due to the swing of the link member. Therefore, the angle of the link member inclined with respect to the operating rod is changed. As a result, the angle of the link member inclined with respect to the biasing member is also changed. For this reason, the biasing member presses the link member in different directions according to the swing of the link member. Accordingly, the biasing member can suppress the vibration of the link member.

The biasing member may be in contact with one end of the link member and may press the link member toward the other end of the link member. One end of the link member is an end that is connected to the stem. One end is more distant from the operating rod than the other end of the link member. For this reason, since the biasing member connected to the operating rod is largely bent, a force to be generated by the biasing member is increased. Accordingly, the vibration of the link member can be suppressed.

A leaf spring may be used as the biasing member.

A recessed portion to which the biasing member is to be fitted may be formed on the connecting unit, and the recessed portion may extend in a direction where the biasing member extends. Accordingly, the biasing member can be fitted to the recessed portion. Therefore, the displacement of the biasing member can be suppressed in the width direction crossing the longitudinal direction of the biasing member.

This disclosure provides a turbocharger that includes the variable flowrate valve mechanism. The turbocharger includes a turbine and a compressor that is rotated by drive torque generated from the turbine, and the valve body opens and closes the opening portion of the variable gas-flow-rate passage bypassing the turbine.

In the variable flowrate valve mechanism of the turbocharger, the operating rod connected to the actuator reciprocates. The link member connected to the operating rod swings due to the reciprocation. The stem moves rotationally about the axis of the stem due to the swing. When the stem moves rotationally through the housing, the valve body connected to one end of the stem approaches the opening portion of the variable gas-flow-rate passage. Accordingly, the valve body closes the opening portion. Further, when the valve body is separated from the opening portion of the variable gas-flow-rate passage, the valve body opens the opening portion. Accordingly, the flow rate of gas passing through the variable gas-flow-rate passage can be adjusted. Furthermore, in the variable flowrate valve mechanism, the pair of connecting units is provided on both sides of the link member in the direction where the operating rod reciprocates. The link member is disposed between the pair of connecting units. The biasing member, which is connected to the pair of connecting units, is bent so as to protrude outward in the longitudinal direction of the link member. The biasing member presses the link member in the longitudinal direction of the link member due to the bending of the biasing member. Accordingly, the biasing member damps the vibration of the link member. For this reason, the vibration of the link member in the longitudinal direction is suppressed. Further, the vibration of the stem in the radial direction is suppressed. Accordingly, the vibration of the valve body connected to the stem is damped.

Embodiments of this disclosure will be described in detail below with reference to the drawings. Meanwhile, the same portions or corresponding portions will be denoted in the respective drawings by the same reference numerals and the repeated description thereof will be omitted.

### First Embodiment, Turbocharger

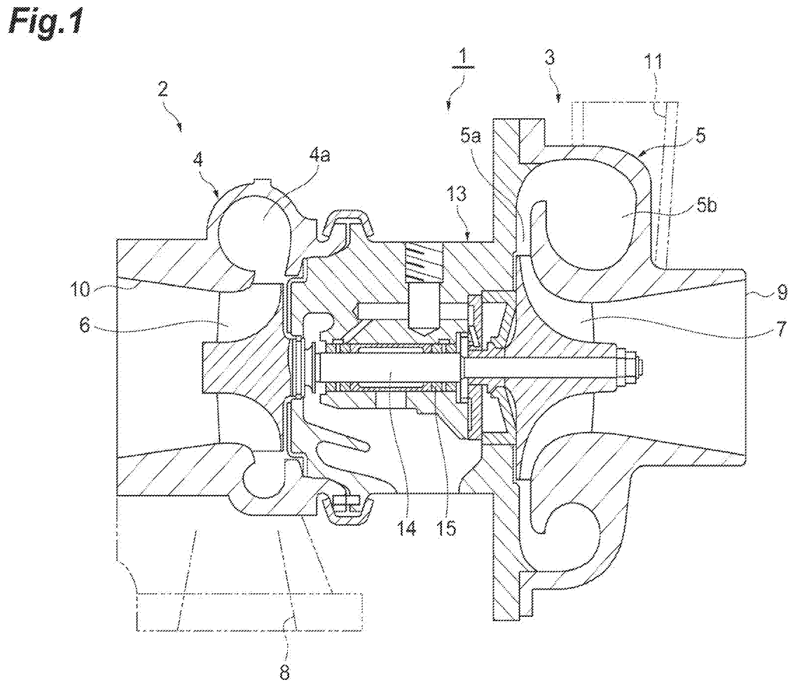

A turbocharger 1 illustrated in FIGS. 1, 2, and 3 is a turbocharger for a vehicle. The turbocharger 1 compresses air, which is supplied to an engine, using an exhaust gas that is discharged from an engine (not illustrated). The turbocharger 1 includes a turbine 2 and a compressor (centrifugal compressor) 3. The turbine 2 includes a turbine housing 4 and a turbine impeller 6. The turbine impeller 6 is received in the turbine housing 4. The compressor 3 includes a compressor housing 5 and a compressor impeller 7. The compressor impeller 7 is received in the compressor housing 5.

The turbine impeller 6 is provided at one end of a rotating shaft 14. The compressor impeller 7 is provided at the other end of the rotating shaft 14. A bearing housing 13 is provided between the turbine housing 4 and the compressor housing 5. The rotating shaft 14 is rotatably supported through bearings 15 by the bearing housing 13.

The turbine housing 4 is provided with an exhaust gas inlet 8 and an exhaust gas outlet 10. An exhaust gas, which is discharged from the engine, flows into the turbine housing 4 through the exhaust gas inlet 8. Subsequently, the exhaust gas rotates the turbine impeller 6. After that, the exhaust gas flows out of the turbine housing 4 through the exhaust gas outlet 10.

The compressor housing 5 is provided with an intake port 9 and a discharge port 11. When the turbine impeller 6 is rotated as described above, the rotating shaft 14 and the compressor impeller 7 are rotated. The compressor impeller 7, which is being rotated, takes in outside air through the intake port 9. Then, the compressor impeller 7 compresses the air. After that, the compressor impeller 7 discharges the compressed air from the discharge port 11. The compressed air, which is discharged from the discharge port 11, is supplied to the engine.

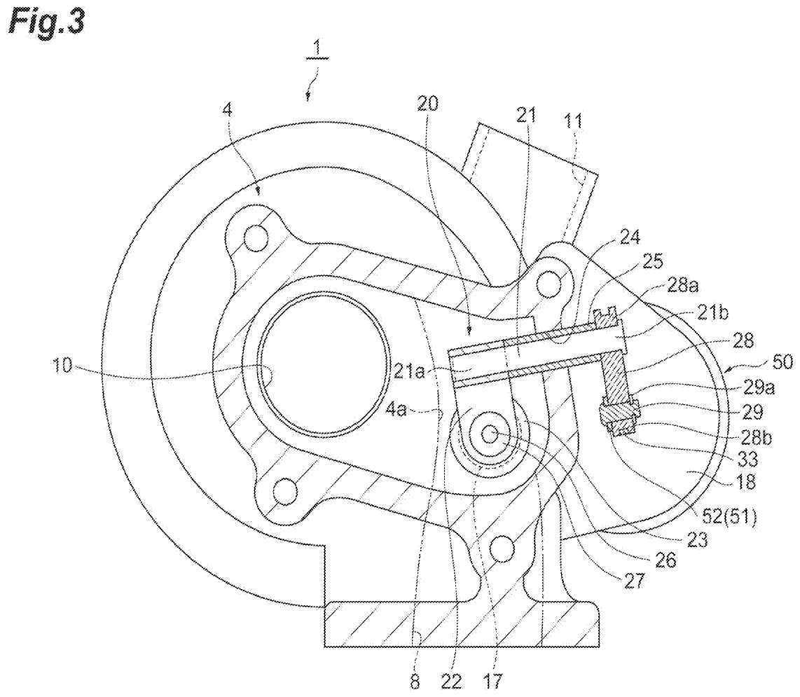

As illustrated in FIG. 3, a bypass passage 17 is formed in the turbine housing 4. The bypass passage 17 allows a part of an exhaust gas, which is introduced from the exhaust gas inlet 8, to bypass the turbine impeller 6 to guide the part of the exhaust gas to the exhaust gas outlet 10. The bypass passage 17 is a variable gas-flow-rate passage. The bypass passage 17 allows the flow rate of an exhaust gas, which is to be supplied to the turbine impeller 6, to be variable.

### Wastegate Valve

The turbocharger 1 includes a wastegate valve 20 as a variable flowrate valve mechanism. The wastegate valve 20 opens and closes an opening portion of the bypass passage 17 facing the exhaust gas outlet 10. The wastegate valve 20 includes a stem 21, a swing piece 22, and a valve body 23. The stem 21 is supported so as to be rotatable relative to the outer wall of the turbine housing 4. The swing piece 22 protrudes from the stem 21 in the radial direction of the stem 21. The valve body 23 is supported by the swing piece 22.

A support hole (through-hole) 24 is formed in the outer wall of the turbine housing 4. The support hole 24 passes through the outer wall in the thickness direction of the outer wall. A cylindrical bush (bearing) 25 is inserted into the support hole 24. The bush 25 is fixed to the outer wall of the turbine housing 4 by being press-fitted.

The stem 21 is inserted into the bush 25. The stem 21 is supported so as to be rotatable relative to the outer wall of the turbine housing 4. The swing piece 22 is fixed to one end 21a of the stem 21. The stem 21 is rotated about the axis of the stem 21. The stem 21 allows the swing piece 22 to swing by the rotation thereof. A mounting hole is provided at the tip portion of the swing piece 22. The valve body 23 is mounted in the mounting hole. For example, the lateral portion of the swing piece 22 is in contact with one end face of the bush 25. Meanwhile, one end and the other end of the bush 25 correspond to one end 21a and the other end 21b of the stem 21. One end of the bush 25 is disposed inside the turbine housing 4. The other end of the bush 25 is disposed outside the turbine housing 4.

The valve body 23 can come into contact with and be spaced apart from the peripheral edge portion of the opening portion of the bypass passage 17. The valve body 23 has the shape of, for example, a disc. The valve body 23 is provided with a valve shaft 26. The valve shaft 26 protrudes to one side opposite to the opening portion of the bypass passage 17. The valve shaft 26 is inserted into the mounting hole that is provided at the tip portion of the swing piece 22. A fastener 27 is fixed to the end portion of the valve shaft 26 opposite to the valve body 23. The valve shaft 26, which is inserted into the mounting hole, is held by the fastener 27. The valve body 23 is supported so as to be slightly movable (including tiltable) relative to the swing piece 22. Accordingly, the valve body 23 slightly moves relative to the swing piece 22. Therefore, the valve body 23 is in close contact with the peripheral edge portion (valve seat) of the opening portion of the bypass passage 17. Further, when the valve body 23 is in contact with the peripheral edge portion of the opening portion of the bypass passage 17, the wastegate valve 20 is in a closed state. On the other hand, when the valve body 23 is separated from the peripheral edge portion of the opening portion of the bypass passage 17, the wastegate valve 20 is in an open state.

The wastegate valve 20 includes an actuator 50, an operating rod 51, and a link member 28. The actuator 50 drives the valve body 23. The operating rod 51 is connected to the actuator 50 and reciprocates. A first end portion (one end, base end portion) 28a of the link member 28 is connected to the stem 21. A second end portion (the other end, tip portion) 28b of the link member 28 is connected to the operating rod 51. Further, the wastegate valve 20 includes a vibration suppression unit 30. The vibration suppression unit 30 suppresses the vibration of the link member 28.

The link member 28 has the shape of, for example, a plate. The link member 28 extends in a direction that crosses the stem 21 and the operating rod 51. The first end portion 28a of the link member 28 is fixed to the other end (base end) 21b. The other end 21b of the stem 21 is disposed outside the turbine housing 4. A mounting hole is formed at the first end portion 28a of the link member 28. The mounting hole passes through the link member 28 in the thickness direction of the link member 28. The other end 21b of the stem 21 is inserted into the mounting hole of the first end portion 28a of the link member 28. Further, the link member 28 is disposed so as to protrude in the radial direction of the stem 21.

A mounting hole is formed at the second end portion 28b of the link member 28. A connecting pin 29 is inserted into the mounting hole. The link member 28 is connected to the operating rod 51 through the connecting pin 29 that is inserted into the mounting hole.

The connecting pin 29 is inserted into the mounting hole of the second end portion 28b of the link member 28 and a mounting hole of the operating rod 51. The mounting hole of the operating rod 51 is formed, for example, at a middle portion of the operating rod 51 in a longitudinal direction.

One end of the connecting pin 29 is connected to the operating rod 51 by caulking. A clip 29a is mounted on the other end of the connecting pin 29. The clip 29a prevents the separation of the connecting pin 29 from the mounting hole. The stem 21 is connected to the operating rod 51 of the actuator 50 through the link member 28 and the connecting pin 29.

A groove portion (recessed portion) 41 is formed on the lateral surface of the link member 28. The groove portion 41 is continuous over the entire circumference of the lateral surface of the link member 28. Meanwhile, the lateral surface of the link member 28 is the surface of the link member 28 along the thickness direction. A leaf spring member 33 of the vibration suppression unit 30 to be described later is inserted into the groove portion 41, so that the leaf spring member 33 is disposed in the groove portion 41.

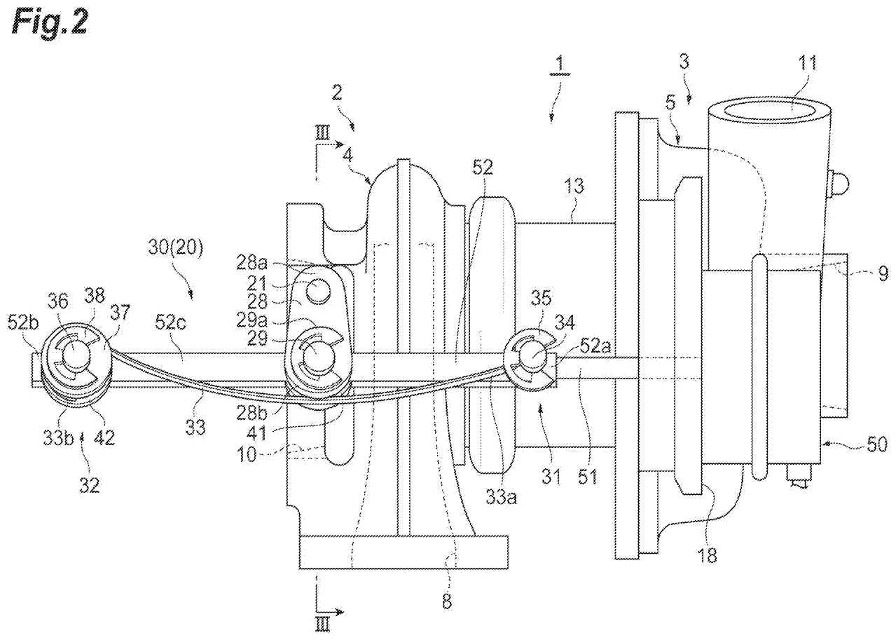

As illustrated in FIG. 2, the operating rod 51 is a rod-like member that reciprocates. Power generated by the actuator 50 is transmitted to the operating rod 51, so that the operating rod 51 reciprocates. The operating rod 51 includes a flat plate portion 52 that extends in the longitudinal direction of the operating rod 51. The shape of the cross-section of the flat plate portion 52, which crosses the longitudinal direction, is, for example, a rectangular shape. The flat plate portion 52 is disposed so that the thickness direction of the flat plate portion 52 is along the direction of the axis of the stem 21.

The mounting hole is formed at a middle portion of the flat plate portion 52 in the longitudinal direction. The above-mentioned connecting pin 29 is inserted into the mounting hole. Further, mounting holes are formed at both end portions (52a, 52b) of the flat plate portion 52 in the longitudinal direction. The mounting holes pass through in the thickness direction. The mounting holes, which are provided at both end portions of the flat plate portion 52 in the longitudinal direction, support a pair of connecting units 31 and 32 of the vibration suppression unit 30 to be described later. Meanwhile, the pair of connecting units 31 and 32 includes a first connecting unit 32 and a second connecting unit 31.

The flat plate portion 52 includes a protruding portion 52c. The protruding portion 52c protrudes to one side of the connecting pin 29 opposite to the actuator 50. The connecting pin 29 is a part to be connected to the link member 28. The first connecting unit 32 is mounted on the protruding portion 52c.

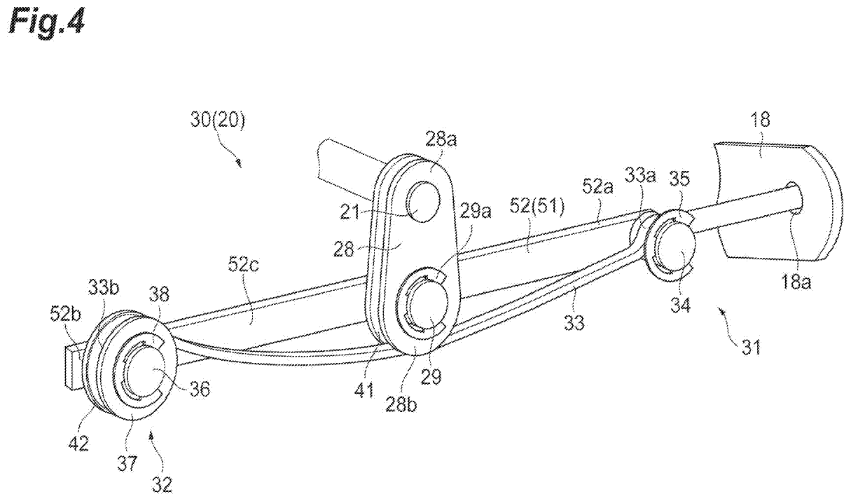

The actuator 50 is, for example, a diaphragm-type actuator. The actuator 50 is fixed to, for example, a bracket 18. The bracket 18 is fixed to the compressor housing 5. The operating rod 51 extends toward the turbine 2 from the compressor 3 in the direction of the axis of the rotating shaft 14 of the turbocharger 1. The operating rod 51 connected to the actuator 50 passes through an opening 18a (see FIG. 4) that is formed in the bracket 18. Further, the operating rod 51 extends toward the turbine 2. The actuator 50 allows the operating rod 51 to reciprocate in the direction of the axis of the operating rod 51. The actuator 50 allows the link member 28 to swing due to the reciprocation. Accordingly, the actuator 50 allows the stem 21 to be rotated about the axis of the stem 21.

### Vibration Suppression Unit

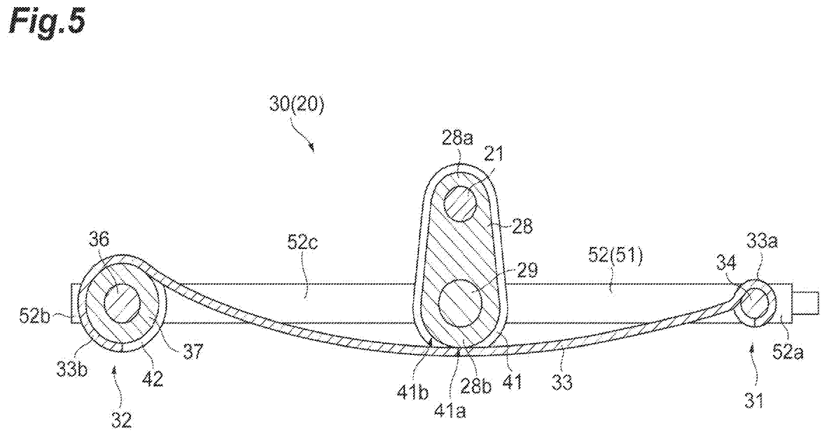

The wastegate valve 20 includes the vibration suppression unit 30 as described above. The vibration suppression unit 30 suppresses the vibration of the link member 28. As illustrated in FIGS. 2, 4, and 5, the vibration suppression unit 30 includes the pair of connecting units 31 and 32 and the leaf spring member (biasing member) 33. The pair of connecting units 31 and 32 faces each other in a direction where the operating rod 51 reciprocates. The pair of connecting units 31 and 32 is disposed on both sides of the link member 28. The leaf spring member 33 is connected to the pair of connecting units 31 and 32. Since the pair of connecting units 31 and 32 is disposed on both sides of the link member 28 in a direction where the link member 28 swings, the pair of connecting units 31 and 32 face each other.

The second connecting unit 31, which is one connecting unit of the pair of connecting units 31 and 32, is disposed on one side facing the actuator 50 in the longitudinal direction of the operating rod 51. The first connecting unit 32, which is the other connecting unit, is disposed on one side opposite to the actuator 50. The pair of connecting units 31 and 32 is mounted on the operating rod 51.

The second connecting unit 31 includes a support pin 34 and a clip 35. The support pin 34 is inserted into the mounting hole of the operating rod 51 that is provided on one side facing the actuator 50. The clip 35 is mounted on the support pin 34. The support pin 34 has a columnar shape. The support pin 34 is fixed to the operating rod 51 by being inserted into the mounting hole formed in the operating rod 51. The support pin 34 is disposed so as to protrude from the operating rod 51 to one side opposite to the turbine housing 4 in the thickness direction of the flat plate portion 52. The outer peripheral surface of the support pin 34 is used as a surface around which one end 33a of the leaf spring member 33 is wound.

The clip 35 has the shape of, for example, a plate. The clip 35 is formed so as to have a C shape when viewed in the thickness direction. The clip 35 is mounted on the support pin 34. The clip 35 regulates the position of the leaf spring member 33 in the direction of the axis of the support pin 34.

The first connecting unit 32 includes a support pin 36, a rubber member (elastic part) 37, and a clip 38. The support pin 36 is inserted into the mounting hole of the operating rod 51 that is provided on one side opposite to the actuator 50. The rubber member 37 is mounted on the support pin 36. The clip 38 regulates the position of the rubber member 37 by being mounted on the support pin 36. The support pin 36 has a columnar shape. The support pin 36 is fixed to the operating rod 51 by being inserted into the mounting hole formed in the operating rod 51. The support pin 36 is disposed so as to protrude from the operating rod 51 to one side opposite to the turbine housing 4 in the thickness direction of the flat plate portion 52. The support pin 36 protrudes in the same direction as the support pin 34 that is provided on the side facing the actuator 50.

The rubber member 37 has the shape of, for example, a disc. An opening portion, which passes through in a thickness direction, is formed at the central portion of the rubber member 37. The support pin 36 is inserted into the opening portion, so that the rubber member 37 is mounted on the support pin. A groove portion (recessed portion) 42 is formed on the outer peripheral surface of the rubber member 37. The groove portion 42 is continuous in the circumferential direction. The other end 33b of the leaf spring member 33 is inserted into the groove portion 42.

The clip 38 has the shape of, for example, a plate. The clip 38 is formed so as to have a C shape when viewed in the thickness direction. The clip 38 regulates the position of the rubber member 37 in the direction of the axis of the support pin 36 by being mounted on the support pin 36.

The leaf spring member 33 has the shape of a flat plate having a predetermined length. The leaf spring member 33 is made of, for example, a metal material having elasticity. Since the leaf spring member 33 is suspended from the pair of connecting units 31 and 32, the leaf spring member 33 is disposed while being bent.

One end 33a of the leaf spring member 33 is supported by being wound around the support pin 34 of the second connecting unit 31. One end 33a of the leaf spring member 33 is disposed clockwise in FIGS. 2, 4, and 5 from the link member 28 (the left side in FIGS. 2, 4, and 5) in the circumferential direction of the support pin 34. One end 33a passes by the upper side in FIGS. 2, 4, and 5 and the side facing the actuator 50 (the right side in FIGS. 2, 4, and 5), and reaches the lower side in the drawings. Meanwhile, one end 32a of the leaf spring member 33 may be wound around the support pin 34 one or more times. Further, one end 32a may be wound less than one time.

The other end 33b of the leaf spring member 33 is supported by being wound around the support pin 36 of the first connecting unit 32. The other end 33b of the leaf spring member 33 is disposed counterclockwise in FIGS. 2, 4, and 5 from the link member 28 (the right side in FIGS. 2, 4, and 5) in the circumferential direction of the rubber member 37. The other end 33b passes by the upper side in the drawings and one side opposite to the actuator 50 (the left side in FIGS. 2, 4, and 5), and reaches the lower side in the drawings. Meanwhile, the other end 33b of the leaf spring member 33 may be wound around the rubber member 37 one or more times. Further, the other end 33b may be wound less than one time.

The middle portion of the leaf spring member 33 in the longitudinal direction is inserted into the groove portion 41 of the second end portion 28b of the link member 28. In addition, the middle portion is in contact with the second end portion 28b of the link member 28. The groove portion 41 of the link member 28 has a depth and a width corresponding to the appearance of the leaf spring member 33. In a state where the leaf spring member 33 is inserted into the groove portion 41, the leaf spring member 33 is in contact with a bottom 41a and lateral surfaces 41b and 41b of the groove portion 41. The lateral surfaces 41b and 41b of the groove portion 41 are the surfaces of the groove portion 41 that face each other in the width direction of the groove portion 41.

The second end portion 28b of the link member 28 protrudes to one side of the operating rod 51 opposite to the stem 21. For this reason, since the middle portion of the leaf spring member 33 of which both end portions are connected to the operating rod 51 is in contact with the second end portion 28b of the link member 28, the leaf spring member 33 is bent so as to protrude to one side opposite to the stem 21. Accordingly, the leaf spring member 33 presses the other end of the link member 28 toward the stem 21. Meanwhile, the longitudinal direction of the link member 28 is a direction along the long side of the link member 28. The longitudinal direction of the link member 28 is a direction along the radial direction of the stem 21 in a state where the link member 28 is connected to the stem 21.

Next, the action and effect of the turbocharger 1 will be described.

An exhaust gas, which flows in from the exhaust gas inlet 8, passes through a turbine scroll flow passage 4a. Then, the exhaust gas is supplied to the inlet side of the turbine impeller 6. The turbine impeller 6 generates torque using the pressure of the supplied exhaust gas. This torque allows the rotating shaft 14 and the compressor impeller 7 to rotate integrally with the turbine impeller 6. Accordingly, the turbocharger 1 compresses air, which is taken in from the intake port 9 of the compressor 3, using the compressor impeller 7. The air, which is compressed by the compressor impeller 7, passes through a diffuser flow passage 5a and a compressor scroll flow passage 5b. After that, the compressed air is discharged from the discharge port 11. The air, which is discharged from the discharge port 11, is supplied to the engine.

When boost pressure (the pressure of the air discharged from the discharge port 11) reaches set pressure during the operation of the turbocharger 1, the actuator 50 is driven. The operating rod 51 is pushed out by the driving of the actuator 50. A pushing force (driving force), which is generated by the operating rod 51, is transmitted to the valve body 23 through the link member 28 connected to the operating rod 51, the stem 21, and the swing piece 22. Accordingly, the valve body 23 is moved so as to be separated from the peripheral edge portion of the opening portion of the bypass passage 17. Then, the wastegate valve 20 is in an open state. In this case, a part of the exhaust gas, which flows in from the exhaust gas inlet 8 bypasses the turbine impeller 6 by passing through the bypass passage 17. For this reason, the turbocharger 1 can reduce the flow rate of the exhaust gas that is supplied to the turbine impeller 6.

On the other hand, when boost pressure becomes less than the set pressure during the operation of the turbocharger 1, the pushing force generated by the operating rod 51 is released. When the pushing force is released, the operating rod 51 is pushed back. Accordingly, the link member 28 swings about the stem 21. Further, the stem 21 is rotated about the axis thereof, so that the swing piece 22 swings. Furthermore, the valve body 23 approaches the peripheral edge portion of the opening portion of the bypass passage 17. Then, the valve body presses the peripheral edge portion of the opening portion. Accordingly, the wastegate valve 20 is in a closed state. That is, this state is a state where the bypassing of the exhaust gas through the bypass passage 17 is not performed in the turbine 2.

The wastegate valve 20 of the turbocharger 1 includes the leaf spring member 33 that presses the link member 28. The leaf spring member 33 is bent so as to protrude outward in the longitudinal direction of the link member 28, and presses the link member 28 toward the first end portion 28a from the second end portion 28b. Accordingly, the wastegate valve 20 suppresses the generation of the vibration of the link member 28. In addition, the wastegate valve 20 can damp the vibration of the link member 28. In the wastegate valve 20, the leaf spring member 33 presses the link member 28 in the longitudinal direction of the link member 28. Accordingly, vibration in the longitudinal direction of the link member 28 and vibration in the radial direction of the stem 21 are suppressed. Therefore, the wastegate valve 20 can damp the vibration of the valve body 23 that is connected to the stem 21.

The leaf spring member 33 is in contact with the second end portion 28b of the link member 28 and presses the link member 28 toward the first end portion 28a. The second end portion 28b of the link member 28 is a portion that is connected to the operating rod 51. The position of the second end portion 28b is changed due to the swing of the link member 28. Accordingly, since the angle of the link member 28 inclined with respect to the operating rod 51 is changed, the angle of the link member 28 inclined with respect to the leaf spring member 33 is also changed. For this reason, the link member 28 is biased in different directions according to the swing of the link member 28. Accordingly, the wastegate valve 20 can suppress the vibration of the link member 28.

Both the end portions (33a, 33b) of the leaf spring member 33 are connected to the operating rod 51. Accordingly, the leaf spring member 33 can suppress the vibration of the link member 28 with respect to the operating rod 51. For this reason, the leaf spring member 33 can suppress vibration that is transmitted to the operating rod 51 from the link member 28.

The first connecting unit 32 includes the rubber member 37 that is mounted on the support pin 36. The other end 33b of the leaf spring member 33 is supported through the rubber member 37 by the operating rod 51. Accordingly, a force acting on the leaf spring member 33 is reduced by the rubber member 37. As a result, the vibration of the link member 28 is further reduced.

A recessed portion to which the leaf spring member 33 is to be fitted is formed on the rubber member 37 of the first connecting unit 32. Accordingly, the leaf spring member 33 can be fitted to the recessed portion. Therefore, the wastegate valve 20 can suppress the displacement of the leaf spring member 33 in the width direction crossing the longitudinal direction of the leaf spring member 33.

The groove portion 41 to which the leaf spring member 33 is to be fitted is formed on the link member 28. Accordingly, the leaf spring member 33 can be fitted to the groove portion 41. Therefore, the wastegate valve 20 can suppress the displacement of the leaf spring member 33 in the width direction crossing the longitudinal direction of the leaf spring member 33. Further, the leaf spring member 33 is fitted to the groove portion 41. Accordingly, the wastegate valve 20 can prevent the positional deviation of the leaf spring member 33 in the width direction (a direction crossing the longitudinal direction). Therefore, the leaf spring member 33 can be reliably pressed against the link member 28.

### Second Embodiment

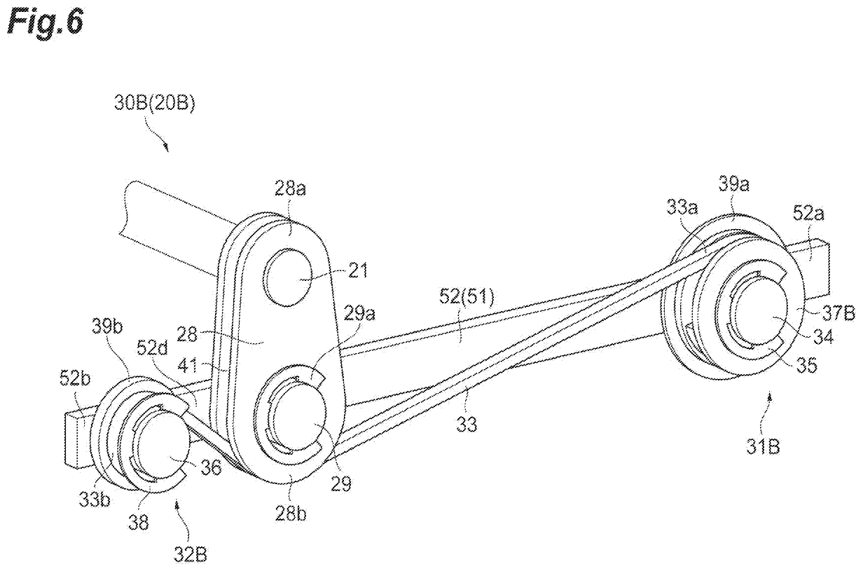

A wastegate valve according to a second embodiment will be described. The wastegate valve 20B of the second embodiment illustrated in FIG. 6 is different from the wastegate valve 20 of the first embodiment in terms of the length of the operating rod 51 and the structure of a vibration suppression unit 30B. Meanwhile, the same description of the second embodiment as the description of the first embodiment will be omitted.

The length of an operating rod 51 of the wastegate valve 20B of the second embodiment is shorter than that of the operating rod 51 of the first embodiment. Specifically, the length of the flat plate portion 52 is short. The length of a protruding portion 52d, which protrudes from the link member 28 to one side opposite to the actuator 50, in the longitudinal direction of the operating rod 51 is short.

A vibration suppression unit 30B according to the second embodiment includes a pair of connecting units 31B and 32B and a leaf spring member (biasing member) 33. The pair of connecting units 31B and 32B is disposed so as to face each other with the link member 28 interposed therebetween in a direction where the link member 28 swings. The leaf spring member 33 is connected to the pair of connecting units 31B and 32B.

The pair of connecting units 31B and 32B includes a first connecting unit 32B and a second connecting unit 31B. The second connecting unit 31B is disposed on one side facing the actuator 50 in the longitudinal direction of the operating rod 51. The first connecting unit 32B is disposed on one side opposite to the actuator 50. The pair of connecting units 3113 and 32B is mounted on the operating rod 51.

The second connecting unit 31B includes a support pin 34, a spacer 39a, a rubber member 37B, and a clip 35. The spacer 39a is mounted on the support pin 34. The rubber member 37B is mounted on the support pin 34. The spacer 39a has the shape of a ring. The cross-section of the spacer 39a orthogonal to the circumferential direction of the spacer 39a has the shape of a plate. The support pin 34 is inserted into the central opening of the spacer 39a. The spacer 39a is disposed between the flat plate portion 52 of the operating rod 51 and the rubber member 37B in the direction of the axis of the support pin 34. For example, the outer diameter of the spacer 39a is larger than the outer diameter of the rubber member 37B. Further, the spacer 39a is formed of a member having, for example, thermal insulation properties. Accordingly, the spacer 39a can suppress the influence of radiant heat transferred from the turbine housing 4. Accordingly, the spacer 39a can suppress the influence of heat on the rubber member 37B.

The rubber member 37B is different from the rubber member 37 of the first embodiment in terms of only disposition. Accordingly, the structure of the rubber member 37B is the same as that of the rubber member 37 of the first embodiment.

The first connecting unit 32B includes a support pin 36, a spacer 39b, and a clip 38. The spacer 39b is mounted on the support pin 36. The structure of the spacer 39b of the first connecting unit 32B is the same as that of the spacer 39a of the second connecting unit 31B. The spacer 39b is disposed between the flat plate portion 52 of the operating rod 51 and the leaf spring member 33 in the direction of the axis of the support pin 36. For example, the outer diameter of the spacer 39b is larger than the outer diameter of the other end 33b of the leaf spring member 33. The other end 33b is wound around the support pin 36 and has the shape of an arc. Accordingly, the spacer 39b can suppress the influence of heat on the other end 33b of the leaf spring member 33.

The wastegate valve 20B of the second embodiment has the same effects as the effects of the wastegate valve 20 of the first embodiment.

The length of the protruding portion 52d of the operating rod 51 of the wastegate valve 20B can be made short. Accordingly, the wastegate valve 20B can save space. For example, the length of the protruding portion 52d of the operating rod 51 is a distance between the mounting hole for the connecting pin 29 and the other end 52b.

### Third Embodiment

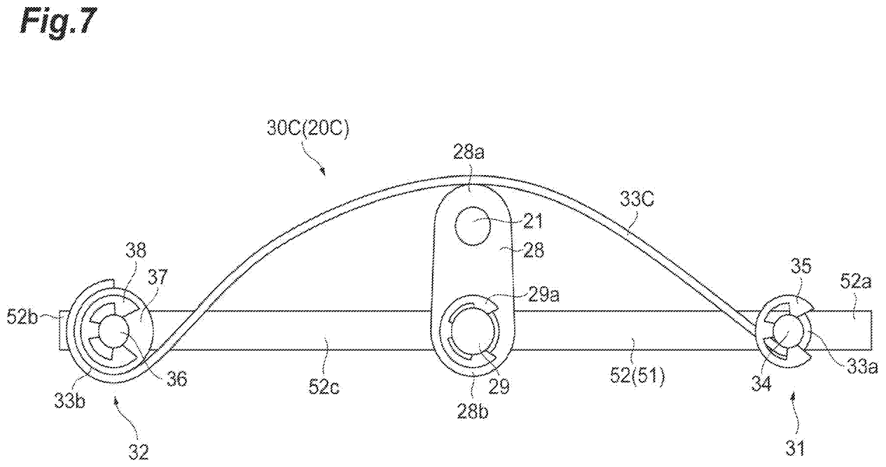

A wastegate valve according to a third embodiment will be described. The wastegate valve 20C of the third embodiment illustrated in FIG. 7 is different from the wastegate valve 20 of the first embodiment in that a vibration suppression unit 30C is included instead of the vibration suppression unit 30. The vibration suppression unit 30 includes the leaf spring member 33, but the vibration suppression unit 30C includes a leaf spring member 33C. The leaf spring member 33 is in contact with the second end portion 28b of the link member 28, but the leaf spring member 33C is in contact with the first end portion 28a of the link member 28. Meanwhile, the same description of the third embodiment as the description of the first and second embodiment will be omitted.

The vibration suppression unit 30C includes a pair of connecting units 31 and 32 and a leaf spring member 33C. Meanwhile, the pair of connecting units 31 and 32 includes a first connecting unit 32 and a second connecting unit 31.

One end 33a of the leaf spring member 33C is supported by being wound around the support pin 34 of the second connecting unit 31. One end 33a of the leaf spring member 33C is disposed counterclockwise in FIG. 7 from the link member 28 (the right side in FIG. 7) in the circumferential direction of the support pin 34. One end 33a passes by the lower side in FIG. 7 and the side facing the actuator 50 (the right side in FIG. 7), and reaches the upper side in FIG. 7.

The other end 33b of the leaf spring member 33C is supported by being wound around the support pin 36 of the first connecting unit 32. The other end 33b of the leaf spring member 33 is disposed clockwise in FIG. 7 from the link member 28 (the right side in FIG. 7) in the circumferential direction of the rubber member 37. The other end 33b passes by the lower side in FIG. 7 and one side opposite to the actuator 50 (the left side in FIG. 7), and reaches the upper side in FIG. 7. For example, a groove portion may be formed on the outer peripheral surface of the rubber member 37 of the first connecting unit 32. A groove portion may not be formed on the outer peripheral surface of the rubber member 37 of the first connecting unit 32.

The middle portion of the leaf spring member 33C in the longitudinal direction is in contact with the end face of the second end portion 28b of the link member 28. Meanwhile, a groove portion into which the leaf spring member 33C is to be inserted may be formed on the link member 28. A groove portion may not be formed on the link member 28. A groove portion is not formed on the link member 28 illustrated in FIG. 7. The leaf spring member 33C is in contact with the end face of the first end portion 28a of the link member 28.

The wastegate valve 20C of the third embodiment has the same effects as the effects of the wastegate valve 20 of the first embodiment.

Since the leaf spring member 33C is in contact with the first end portion 28a of the link member 28 in the vibration suppression unit 30C, the leaf spring member 33C is bent. A distance between the connecting pin 29 and the end face of the first end portion 28a in the longitudinal direction of the link member 28 is longer than a distance between the connecting pin 29 and the end face of the second end portion 28b. For this reason, the curvature of the leaf spring member 33C can be made large. Accordingly, a pressing force, which is generated by the leaf spring member 33C, can be made larger than a pressing force that is generated by the leaf spring member 33. As a result, the vibration of the link member 28 can be suitably suppressed.

This disclosure is not limited to the above-mentioned embodiments, and may have the following various modifications without departing from the scope of this disclosure.

Cases where the connecting units 31 and 32 are mounted on the operating rod 51 have been described in the above-mentioned embodiments. For example, one of the pair of connecting units 31 and 32 may be mounted on a component other than the operating rod 51. For example, the second connecting unit 31 may be fixed to the bracket 18 that supports the actuator 50. For example, the first connecting unit 32 may be fixed to a support member that is fixed to the turbine housing 4. Both of the pair of connecting units 31 and 32 may be mounted on a component other than the operating rod 51.

In the above-mentioned embodiments, one of the pair of connecting units 31 and 32 has been provided with the rubber member 37. For example, each of the pair of connecting units 31 and 32 may be provided with the rubber member 37. Further, the end portion of the leaf spring member 33 has been supported through the rubber member 37. For example, both end portions of the leaf spring member 33 may be supported through the rubber members 37. Furthermore, the elastic part is not limited to the rubber member. The elastic part may be made of a resin. The elastic part may be made of other materials.

The leaf spring member 33 has been used as the biasing member in the above-mentioned embodiments. However, a spring member is not limited to the leaf spring member 33. For example, a rod-like member having a circular cross-section may be used as the biasing member. Further, the biasing member may have other shapes. The cross-section of the biasing member may have, for example, a V shape, a triangular shape, a trapezoidal shape, or the like. The biasing member has only to have elasticity and to be capable of biasing the link member 28. Further, a plurality of kinds of biasing members may be provided as the vibration suppression units.

The operating rod 51 may not include the protruding portion 52c. In the case of this structure, the first connecting unit 32 may be mounted on a component other than the operating rod 51.

The operating rod 51 is not limited to a member that includes the flat plate portion 52. The cross-section of the operating rod 51 may have, for example, a circular shape or the like.

The link member 28 is not limited to a structure that is connected to the operating rod 51 through the connecting pin 29 protruding from the lateral surface of the operating rod 51. An opening portion may be formed in the operating rod 51, the second end portion 28b of the link member 28 may be inserted into the opening portion, and the link member 28 may be connected to the operating rod 51 through a connecting pin of which both end portions disposed in the opening portion are supported by the operating rod 51.

In the above-mentioned embodiments, the turbocharger 1 in which the wastegate valve 20 is employed has been exemplified as a turbocharger for a vehicle. However, the turbocharger in which the wastegate valve 20, is not limited to a turbocharger for a vehicle. For example, the turbocharger in which the wastegate valve 20 is employed may be used for a marine engine. Further, the turbocharger in which the wastegate valve 20 is employed may be used for other engines.

### REFERENCE SIGNS LIST

1: turbocharger, 4: turbine housing (housing), 17: bypass passage, 18: bracket, 20: wastegate valve (variable flowrate valve mechanism), 21: stem, 21a: one end of stem, 23: valve body, 28: link member, 28a: first end portion (one end) of link member, 28b: second end portion (the other end) of link member, 30, 30B, 30C: vibration suppression unit, 31: second connecting unit (pair of connecting units, second connecting unit), 32: first connecting unit (pair of connecting units, first connecting unit), 33, 33C: leaf spring member (biasing member), 37, 37B: rubber member (elastic part), 39a, 39b: spacer, 50: actuator, 51: operating rod, 52: flat plate portion, 52c, 52d: protruding portion.

1.-10. (canceled)

11. A variable flowrate valve mechanism that opens and closes an opening portion of a variable gas-flow-rate passage, the variable flowrate valve mechanism comprising:
a valve body that opens and closes the opening portion;
a stem of which one end is connected to the valve body, passes through a housing, and is supported so as to be rotatable relative to the housing;
an operating rod that is connected to an actuator and reciprocates;
a link member of which one end is connected to the stem and the other end is connected to the operating rod and which extends in a direction crossing the stem and the operating rod and swings about an axis of the stem; and
a biasing member that is connected to a pair of connecting units disposed on both sides of the link member in a direction where the operating rod reciprocates, is bent so as to protrude outward in a longitudinal direction of the link member, and presses the link member in the longitudinal direction of the link member.

12. The variable flowrate valve mechanism according to claim 11,
wherein at least one of the pair of connecting units is provided on the operating rod.

13. The variable flowrate valve mechanism according to claim 11,
wherein the operating rod includes a protruding portion that protrudes to one side of a portion of the operating rod, which is connected to the other end of the link member, opposite to the actuator, and
a first connecting unit, which is disposed on one side opposite to the actuator, of the pair of connecting units is provided on the protruding portion.

14. The variable flowrate valve mechanism according to claim 11,
wherein a second connecting unit, which is disposed on one side facing the actuator, of the pair of connecting units is provided on a bracket that supports the actuator.

15. The variable flowrate valve mechanism according to claim 11,
wherein at least one of the pair of connecting units includes an elastic part that is connected to the biasing member.

16. The variable flowrate valve mechanism according to claim 11,
wherein the biasing member is in contact with the other end of the link member and presses the link member toward one end of the link member.

17. The variable flowrate valve mechanism according to claim 11,
wherein the biasing member is in contact with one end of the link member and presses the link member toward the other end of the link member.

18. The variable flowrate valve mechanism according to claim 11,
wherein the biasing member is a leaf spring.

19. The variable flowrate valve mechanism according to claim 11,
wherein a recessed portion to which the biasing member is to be fitted is formed on the connecting unit, and
the recessed portion extends in a direction where the biasing member extends.

20. A turbocharger that includes the variable flowrate valve mechanism according to claim 11, the turbocharger comprising:
a turbine; and
a compressor that is rotated by drive torque generated from the turbine,
wherein the valve body opens and closes the opening portion of the variable gas-flow-rate passage bypassing the turbine.

21. The variable flowrate valve mechanism according to claim 12,
wherein the operating rod includes a protruding portion that protrudes to one side of a portion of the operating rod, which is connected to the other end of the link member, opposite to the actuator, and
a first connecting unit, which is disposed on one side opposite to the actuator, of the pair of connecting units is provided on the protruding portion.

22. The variable flowrate valve mechanism according to claim 21,
wherein a second connecting unit, which is disposed on one side facing the actuator, of the pair of connecting units is provided on a bracket that supports the actuator.

23. The variable flowrate valve mechanism according to claim 22,
wherein at least one of the pair of connecting units includes an elastic part that is connected to the biasing member.

24. The variable flowrate valve mechanism according to claim 23,
wherein the biasing member is in contact with the other end of the link member and presses the link member toward one end of the link member.

25. The variable flowrate valve mechanism according to claim 24,
wherein the biasing member is a leaf spring.

26. The variable flowrate valve mechanism according to claim 25,
wherein a recessed portion to which the biasing member is to be fitted is formed on the connecting unit, and
the recessed portion extends in a direction where the biasing member extends.

27. The variable flowrate valve mechanism according to claim 23,
wherein the biasing member is in contact with one end of the link member and presses the link member toward the other end of the link member.

28. The variable flowrate valve mechanism according to claim 27,
wherein the biasing member is a leaf spring.

29. The variable flowrate valve mechanism according to claim 28,
wherein a recessed portion to which the biasing member is to be fitted is formed on the connecting unit, and
the recessed portion extends in a direction where the biasing member extends.
